(19) United States
(12) Patent Application Publication
(10) Pub. No.: US 2026/0099808 A1
(43) Pub. Date: Apr. 9, 2026

(54) PALLET LABEL CHECK

(71) Applicant: Walmart Apollo, LLC, Bentonville, AR (US)

(72) Inventors: Chongrui Zhao, San Mateo, CA (US); Eric W. Rader, Plano, TX (US); Mitchell Thomas Griffith, Garland, TX (US); Tracy E. Benson, Campbell, CA (US); Zhaoliang Duan, Frisco, TX (US); Han Zhang, Allen, TX (US); Lingfeng Zhang, Flower Mound, TX (US); Mingquan Yuan, Flower Mound, TX (US); William Craig Robinson, Centerton, AR (US); Avinash M. Jade, Bangalore, Karnataka (IN); Benjamin Ellison, San Francisco, CA (US); Zhiwei Huang, Flower Mound, TX (US); Elizabeth Ann Siler, Rogers, AR (US)

(21) Appl. No.: 19/042,214

(22) Filed: Jan. 31, 2025

(30) Foreign Application Priority Data
Oct. 9, 2024 (IN) 202441076494

(51) Int. Cl. G06Q 10/087; G06Q 10/0631; G06V 10/764; G06V 30/12

(52) U.S. Cl. CPC G06Q 10/087; G06Q 10/06311; G06V 10/764; G06V 30/12; G06V 2201/07

(57) ABSTRACT

Examples provide a system for enhanced pallet label checking using computer vision and optical character recognition for faster and more efficient resolution of pallet label exceptions. The system includes a pallet manager component that obtains images of pallets from one or more image capture devices. Computer vision and machine learning is utilized to identify pallet labels on pallets which are missing or damaged such that the pallet labels are at least partially unreadable. An initial pallet label exception is created. The exceptions are assigned scores indicating a degree of confidence that the exceptions are accurate and require attention to resolve the issues associated with each label. The exceptions having high confidence scores are enhanced with customized label check instructions and real time images of the pallets. The enhanced pallet label exceptions assist users in locating pallets and resolving issues associated with pallet labels with greater speed and accuracy.

### BACKGROUND

Labels on pallets typically include a unique identifier used to track, locate, and/or identify pallets and pallet contents. However, pallet labels can be inadvertently removed, lost, damaged, or obscured by other objects. Missing, damaged, unreadable, or misplaced pallet labels cause unproductivity in inventory management and can be labor-and time-consuming to fix. Missing or damaged labels can lead to inventory inaccuracies, extra time spent dropping pallets and restocking items, as well as difficulties in performing other inventory tasks which may lead to lost sales or negative member experiences. Human users can manually check each pallet for accurate labels. However, this is a time-consuming and labor intensive process which can become impractical and cost prohibitive where large numbers of pallets are being managed in a retail environment.

### SUMMARY

Some embodiments provide a system and method for enhanced pallet label check using computer vision. In some embodiments, a pallet having a missing or damaged pallet label is identified using an image of the pallet. The image is generated by an image capture device. An initial label exception associated with the pallet having the missing or damaged pallet label is generated. A confidence score is assigned to the initial label exception. The confidence score indicating a degree of confidence associated with the initial label exception. If the exception is a high confidence exception, the initial label exception is classified according to a type of issue with the pallet label. Initial label exceptions having a score indicating low confidence exceptions are closed. The type of the issue comprising a missing label type of issue or a damaged label type of issue. Customized label check instructions are created based on the type of the issue associated with the pallet label. The customized label check instructions guide a user in locating the pallet and correcting the type of the issue associated with the pallet label. The initial label exception is updated with the customized label check instructions to create an enhanced label exception. The enhanced label exception includes a real-time image of the pallet. The enhanced label exception with the customized label check instructions is presented to a user via a user interface device. This enables improved efficiency locating and correcting problems associated with pallet labels.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for enhanced pallet label check using computer vision (CV).

FIG. 2 is an exemplary block diagram illustrating a retail facility including a plurality of pallets and image capture devices for capturing images of pallet labels.

FIG. 3 is an exemplary block diagram illustrating a label manager for providing customized pallet label check instructions with enhanced pallet label exceptions.

FIG. 4 is an exemplary flow chart illustrating operation of the computing device to automatically generate enhanced pallet label exceptions for improving resolution of pallet label issues.

FIG. 5 is an exemplary flow chart illustrating operation of the computing device to provide customized pallet label check instructions for enhanced pallet label exception handling.

FIG. 6 is an exemplary flow chart illustrating operation of the computing device to automatically handle pallet label checks using computer vision and optical character recognition.

FIG. 7 is an exemplary flow chart illustrating operation of the computing device to update pallet label exceptions using feedback provided by a user.

FIG. 8 is an exemplary flow chart illustrating operation of the computing device to customize exception handling instructions based on a type of the pallet label issue.

FIG. 9 is an exemplary diagram illustrating types of pallet label issues.

FIG. 10 is an exemplary screenshot illustrating pallet label check assignments for checking potential pallet label issues detected in images of pallets.

FIG. 11 is an exemplary screenshot illustrating a prompt for more information associated with a pallet label issue.

FIG. 12 is an exemplary screenshot illustrating a real time image of a pallet associated with an enhanced pallet label exception.

FIG. 13 is an exemplary screenshot illustrating a set of instructions output to a user associated with a pallet label exception associated with a damaged label.

FIG. 14 is an exemplary screenshot illustrating a set of instructions provided to a user for a pallet label exception associated with a missing label issue.

FIG. 15 is an exemplary screenshot illustrating a set of instructions provided to a user associated with a pallet label that is readable and correct.

FIG. 16 is an exemplary screenshot illustrating a set of instructions output to a user associated with a pallet that remains unlocated by the user.

FIG. 17 is an exemplary screenshot illustrating step by step instructions provided to a user attempting to resolve an issue associated with a pallet label exception.

FIG. 18 is an exemplary screenshot illustrating a feature enabling users to track multiple exceptions via an application.

FIG. 19 is an exemplary diagram illustrating detection of pallets and pallet labels using computer vision object detection and recognition.

FIG. 20 is an exemplary diagram illustrating a “show me how” page 2000 including instructions and/or other tips to assist a user in correctly placing a label on a pallet or other item.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples,.” For brevity and clarity of presentation, this implied leading clause is not repeated ad nauseum.

Computer vision (CV) object detection models, such as image recognition as a service (IRAS) models, are used for automated item detection and item identification. These models are trained using manually labeled training data. The training data consists of images with labeled objects in the images. CV can be used to analyze images of pallets captured by image capture devices, such as handheld cameras, cameras mounted to fixtures, and/or cameras mounted to a robotic device. However, when a pallet label is missing, damaged or obscured from view, an associate or robotic device may be unable to identify the pallet. This creates inventory problems as well as makes it more difficult for an associate to locate the correct pallet within a brick-and-mortar store, warehouse, or distribution center (DC).

Referring to the figures, examples of the disclosure enable a pallet label checking system. In some embodiments, a label manager generates customized instructions to assist users in efficiently and quickly locating pallets having pallet label issues and resolve those issues while minimizing search time as well as ensuring pallet issues are handled correctly.

Some embodiments generate a confidence score for each pallet label exception. Only high confidence exceptions associated with a confidence score that exceeds a threshold value are assigned to a user for resolution. Low confidence exceptions having a confidence score that is less than the threshold value are filtered out or closed to prevent false positives. In this manner, the system reduces the error rate associated with exceptions while improving overall efficiency of human users performing pallet label checks in response to high confidence exceptions.

The system, in other embodiments, designates pallet label exceptions as initial label exceptions which are not yet assigned to users for handling. Each initial label exception is assigned a confidence score. The confidence score indicates a degree of confidence that an initial label exception accurately identifies a pallet with a damaged or missing label. The initial label exceptions with low confidence scores are closed without any human intervention. Only those initial exceptions with high confidence scores are enhanced with customized instructions and assigned to a user via a pallet check task. This reduces the number of pallet label exceptions which are assigned as tasks for investigation/resolution by human users, reducing memory and processor usage consumed providing users with guidance in resolving pallet label issues. It further reduces network bandwidth usage expended in transmitting pallet label check task information and other enhanced label exception data to user devices in conjunction with pallet label check tasks.

In still other embodiments, the system provides customized instructions for resolving pallet label exceptions which are customized based on the type of issue associated with the pallet, the location of the pallet, the confidence score associated with the pallet, feedback received from the user and/or the image quality of the pallet images captured by one or more image capture devices. The system updates the instructions in real-time ensuring each user receives accurate and detailed information for resolving the pallet label exceptions. This further reduces processor usage, memory usage, and network bandwidth usage which would be consumed during correction of inventory errors occurring due to pallet labeling errors.

The computing device operates in an unconventional manner by updating an initial label exception with customized instructions and real time images of pallets to generate enhanced label exceptions enabling more efficient resolution of pallet label exceptions and more accurate inventory updates. In this manner, the computing device is used in an unconventional way, and allows reduced pallet label errors with improved inventory update accuracy while reducing inventory errors. The system further reduces system resource usage which would otherwise be consumed in correcting inventory errors, thereby improving the functioning of the underlying computing device.

In other embodiments, the system improves pallet label accuracy and reduces the number of pallets having missing or damaged pallet labels. This reduces the number of unresolved pallet label exceptions occurring during inventory operations which reduces processor load consumed handling the exceptions and correcting inventory errors.

In still other embodiments, the system provides detailed customized instructions to users for resolving pallet label issues presented to the user via a user interface (UI) device. The instructions improve user efficiency via UI interaction while increasing user interaction performance while further reducing the error rate associated with false pallet label exceptions, such as where a pallet label exception is erroneously created for a pallet which has a correct and undamaged pallet label.

In other embodiments, the system provides automatic pallet label exception handling and customizes step-by-step instructions to assist users in locating pallets quickly and accurately replace missing or damaged labels on pallets. This reduces manual labor required to find pallet exceptions. It further enables an increase in the number/percentage of pallets with readable labels. The system further reduces human effort and time consumed locating pallets and updating inventory for restocking by having the robotic devices and pallet manager component automatically update reserve inventory locations every day.

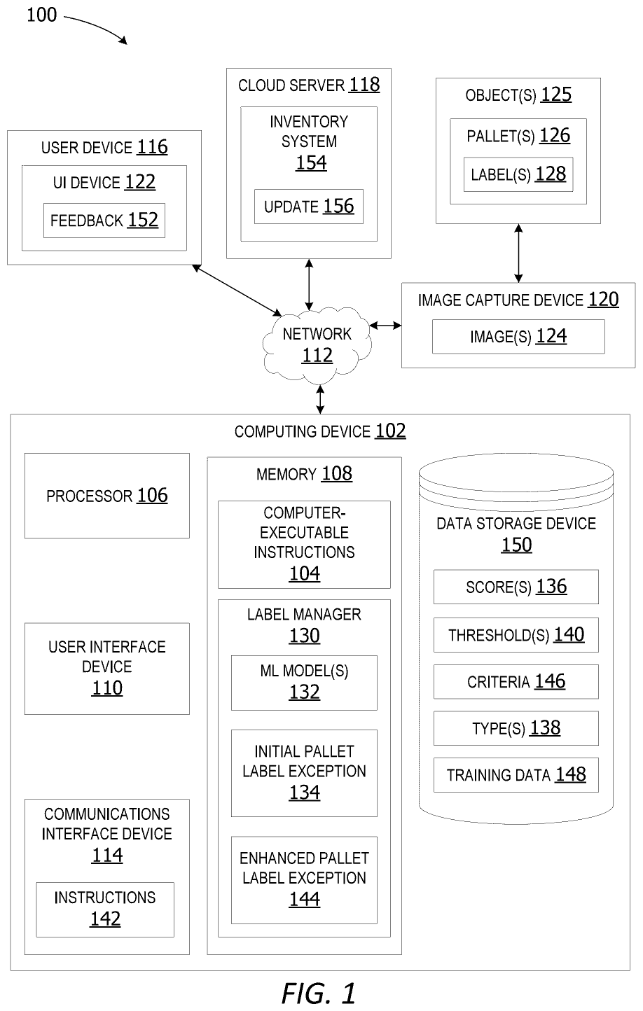

Referring again to FIG. 1, an exemplary block diagram illustrates a system 100 for enhanced pallet label check using computer vision. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

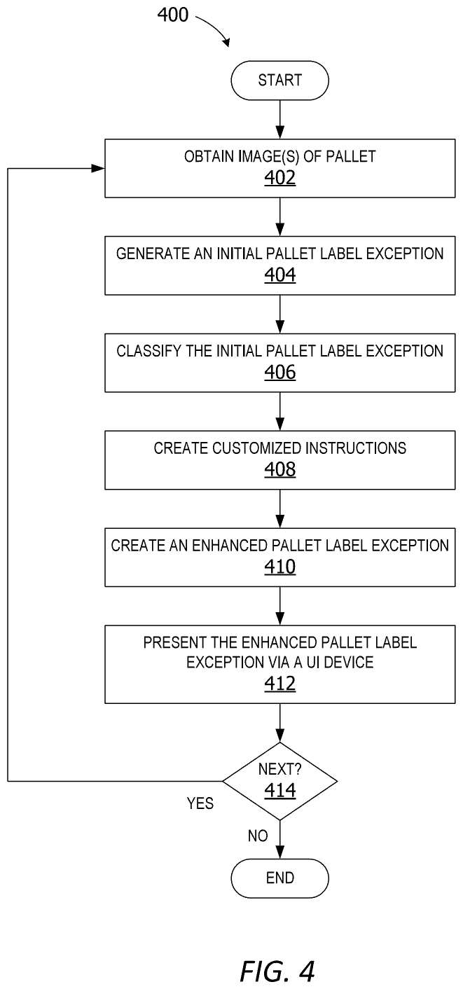

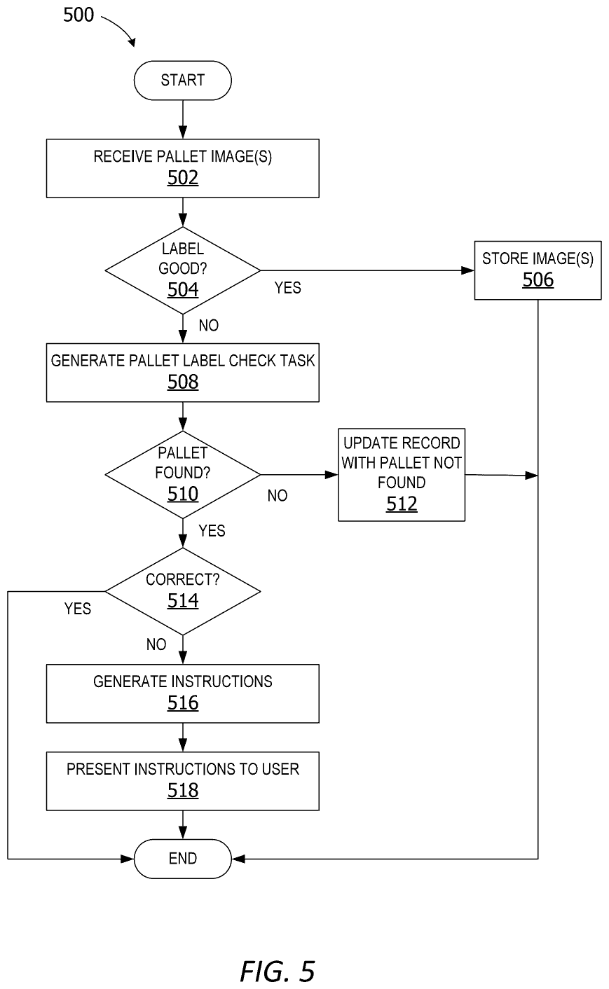

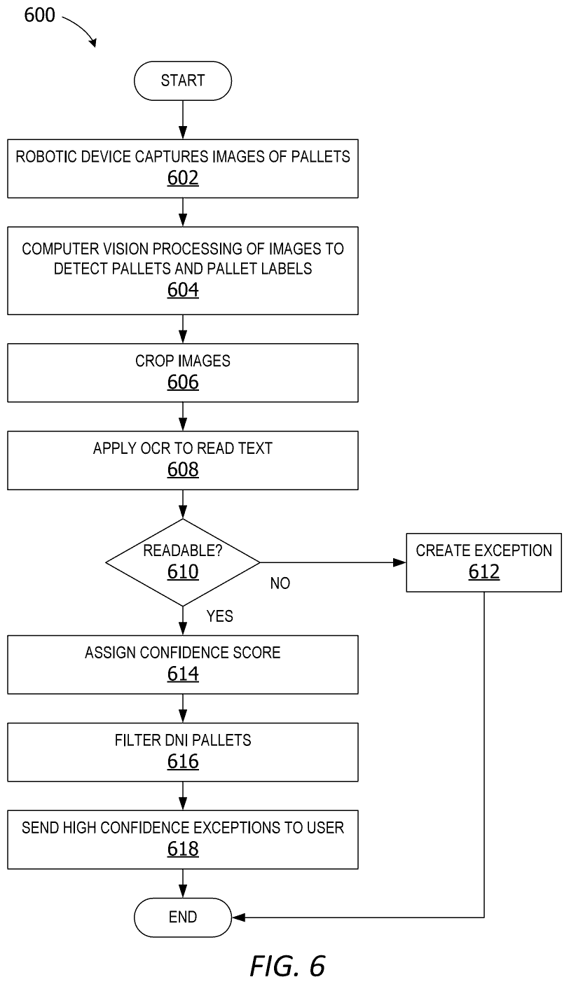

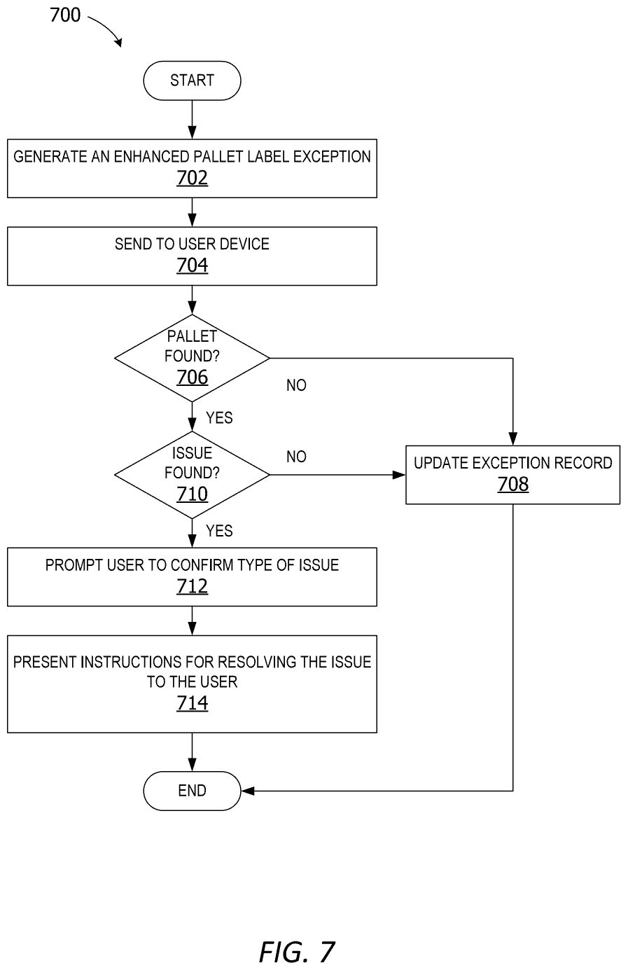

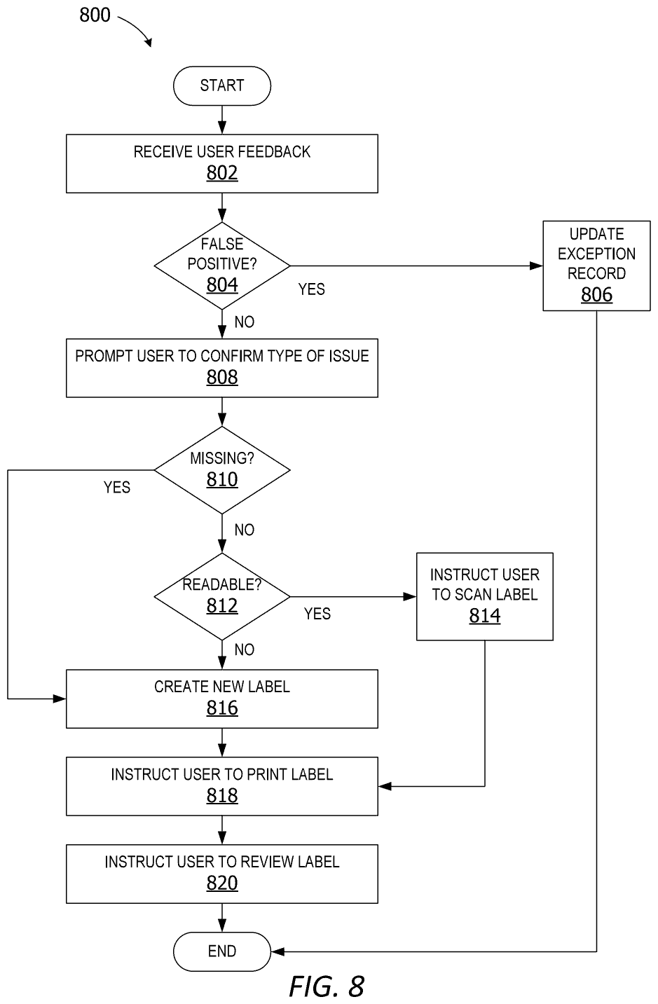

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 4, FIG. 5, FIG. 6, FIG. 7, and FIG. 8).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, and/or one or more image capture device(s) 120, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 122. In some embodiments, the user device 116 includes an inventory application or other pallet label check related application for presenting pallet label check tasks to a user. A pallet label check task is a task assigning a user to locate a pallet associated with a pallet label exception. The pallet label check task in other embodiments further includes task related instructions, such as the customized instructions guiding the user to verify the pallet label issue via feedback and/or resolve the pallet label issue by placing or replacing the pallet label on the pallet having the damaged or missing pallet label, such as a lost label, ripped label, obscured label, or otherwise unreadable label.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other embodiments, the cloud server 118 is associated with a distributed network of servers.

The one or more image capture device(s) 120 include devices for capturing images, such as, but not limited to, a digital camera. The image capture device(s) 120 can include video cameras as well as cameras for capturing still images. The image(s) 124 generated by the image capture device(s) 120 can include black-and-white images, color images, infrared (IR) images, or any other type of images. In this example, the image capture device(s) 120 generate image(s) 124 of one or more object(s) 125, including one or more pallet(s) 126. An object is any type of object of interest. An object can include an individual item, a case of items, a pallet of items or cases of items, etc. Each object of interest in the object(s) 125 includes a label. If the object is a pallet, the pallet includes a pallet label. Thus, the one or more pallet(s) 126, in this example, includes one or more pallet label(s) 128.

In some embodiments, a label is affixed to an exterior surface of a pallet. The pallet label can include alphanumeric characters and/or other symbols or markings. In this example, each pallet label includes a pallet number or other unique pallet identifier. A pallet label can also include text, such as text identifying a manufacturer, source of the pallet, contents of the pallet, etc.

In these embodiments, the image(s) 124 do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest are then analyzed to identify and label the objects of interest within the cropped images, such as, but not limited to, the image(s) 124.

The memory 108 in some embodiments stores one or more computer-executable components, such as a label manager 130. The label manager 130 is a component that, when executed by the processor 106 of the computing device 102, analyzes the image(s) 124 of the pallet(s) 126 to identify a pallet having a missing or damaged pallet label. In some embodiments, the label manager 130 includes one or more machine learning (ML) model(s) 132 for analyzing the image(s) using object detection and recognition to identify pallets and pallet labels in the image(s) 124.

In other embodiments, the label manager 130 generates an initial label exception associated with the pallet having the missing or damaged pallet label. An initial label exception is a provisional or temporary pallet label exception which may be assigned to a human user for a pallet label check and resolution of the exception if the exception is a high confidence exception. The initial label exception may be dismissed or deleted if it is a low confidence exception.

The label manager 130 calculates a confidence score for each initial label exception. The label manager 130 assigns one or more confidence score(s) 136 to the initial pallet label exception 134. The initial pallet label exception is an initial label exception associated with a label on a pallet. A confidence score indicates a degree of confidence associated with the initial pallet label exception 134. If the confidence score for a given initial pallet label exception exceeds one or more threshold(s) 140, the label manager 130 classifies the initial pallet label exception according to one or more type(s) 138 of the issues with the pallet label. The type(s) 138 include a missing label type and/or a damaged label type of issue.

The label manager 130, in some embodiments, creates customized label check instructions 142 based on the type of the issue associated with the pallet label. The customized label check instructions 142 guide a user in locating the pallet and correcting the type of the issue associated with the pallet label. The label manager 130 updates the initial pallet label exception 134 with the customized label check instructions 142 to create an enhanced pallet label exception 144. The enhanced pallet label exception 144 includes the customized label check instructions 142 and a real-time image of the pallet selected from the one or more image(s) 124 of the pallet. In some embodiments, the real time image is the image having the pallet centered within the bounding box of a cropped image of the pallet. In other embodiments, the real time image is selected using criteria 146. The criteria 146 specifies one or more rules for selecting a best image of the pallet for output to the user with the customized instructions 142.

The enhanced pallet label exception 144 including the customized label check instructions 142 via a user interface, such as the user interface device 110 and/or the UI device 122. The enhanced pallet label exception 144 enables improved efficiency locating and correcting the issue associated with the pallet label.

The system 100 can optionally include a data storage device 150 for storing data, such as, but not limited to the confidence score(s) 136, the one or more threshold(s) 140, criteria 146 for selecting a real time image to assist a user in locating a pallet having a label issue, type(s) 138 of the pallet label issues, and/or training data 148.

The training data 148 is data used to train the one or more ML model(s) 132 to detect and recognize pallet(s) 126 and pallet label(s) 128 in one or more image(s) 124 generated by the one or more image capture device(s) 120. In some embodiments, the training data 148 includes labeled training data. In other embodiments, the training data 148 includes feedback 152 received from one or more users. The feedback 152 includes feedback confirming whether the enhanced pallet label exception 144 accurately identified a pallet having a missing or damaged pallet label. The training data 148 is used to fine-tune the ML model(s) 132 to improve the accuracy of the identified pallet label issues and reduce false positives. A false positive occurs where an enhanced pallet label exception 144 identifies a pallet which has a correct and readable pallet label attached to it.

The data storage device 150 can include one or more different types of data storage devices, such as, for example, one or more rotating disks drives, one or more solid state drives (SSDs), and/or any other type of data storage device. The data storage device 150, in some non-limiting embodiments, includes a redundant array of independent disks (RAID) array. In some non-limiting embodiments, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 150 includes a database.

The data storage device 150 in this example is included within the computing device 102, attached to the computing device, plugged into the computing device, or otherwise associated with the computing device 102. In other embodiments, the data storage device 150 includes a remote data storage accessed by the computing device via the network 112, such as a remote data storage device, a data storage in a remote data center, or a cloud storage.

In some embodiments, the enhanced pallet label exceptions are utilized to correct pallet label issues on pallets in a retail facility. The corrected pallet labels are used to update 156 an inventory system 154. In other words, pallet labels are scanned to identify the contents of pallets of items within the retail environment. The inventory system 154 is updated using the data obtained by scanning and/or otherwise reading the pallet labels. Thus, the resolution of pallet label errors ensures more accurate inventory system updates for reduced inventory errors.

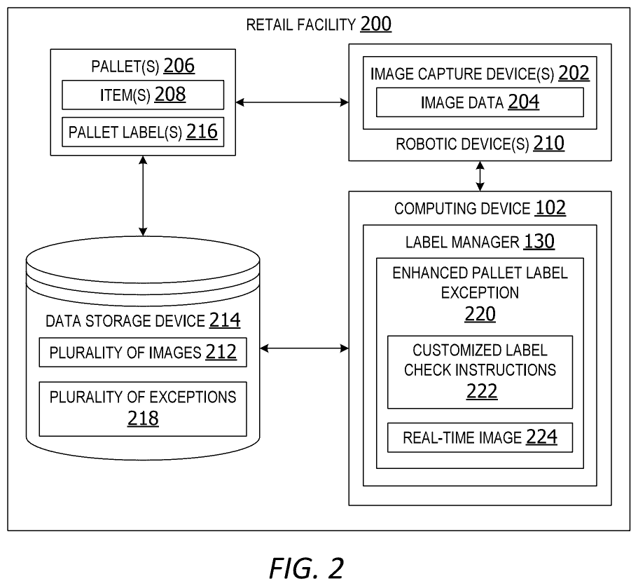

In some embodiments, the system 100 automatically checks pallet labels using computer vision (CV) and mobile robotic devices within a retail facility. The retail facility is any type of brick-and-mortar facility, such as the retail facility 200 shown in FIG. 2 below. The image capture device(s) generate one or more images of one or more pallets. Each pallet contains one or more item(s). The image capture device(s), in some examples, include one or more digital cameras capturing digital images of the pallet(s) or other items in the retail facility. The digital image(s) include image data. In this example, the image capture device(s) include one or more cameras mounted on a mobile robotic device. However, the embodiments are not limited to cameras mounted on a robotic device. In other embodiments, the image capture device(s) include one or more cameras mounted on a fixture, such as a wall, ceiling, shelf, post/pillar, or other fixture. The image capture device(s) can alternatively also include a hand-held camera and/or a camera integrated within a mobile computing device, such as a smartphone.

In other embodiments, the plurality of images generated by the image capture device(s) are optionally stored on a data storage device. The plurality of images include images of one or more pallets. An image of a pallet includes an image of a portion of a pallet. The data storage device is a device for storing data. In other embodiments, the plurality of images are stored on a cloud storage/cloud server.

In some embodiments, the system 100 includes robotic devices, such as, but not limited to, the robotic devices shown in FIG. 2 below. The robotic devices, in these examples, include driverless machines that move around inside the retail facility utilizing a first-of-its-kind dual function design, a powerful new scanning accessory has been fitted to the robotic devices. Installed on the robotic device, these cloud-connected towers scan the pallet labels capturing data as it moves around the store. Using computer vision, the label manager 130 algorithm analyzes the data, and the system can automatically update locations of items and pallets, saving associates time keeping inventory up-to-date.

Missing, damaged, unreadable, or misplaced pallet labels in the club cause unproductivity in inventory management and are very labor-and time-consuming to fix. Missing tags leads to inventory inaccuracies, extra time spent dropping pallets, restocking items, and performing other inventory tasks which may lead to lost sales or negative member experiences.

The system 100, in other embodiments, includes a pallet label check feature for assigning pallet label checking tasks to a user performing a visual inspection of pallets and pallet labels to identify missing or damaged pallet labels and/or replace the pallet labels on pallets. The pallet label check feature, in some embodiments, is provided via a pallet manager application on a mobile user device that leverages robotic devices with mounted camera(s) and computer vision technology to solve the problem, such as the user device 116. The pallet manager application (pallet manager component) analyzes the images of pallets and identifies pallets that do not have readable labels. The system creates pallet label exceptions for club associates to resolve missing tags.

Robotic devices, in some embodiments, are utilized in conjunction with computer vision technology to detect pallet label issues using images captured by the robotic device(s) while scanning throughout a store or other retail facility. Detected issues, in these examples, are added to a prioritized to-do list in the application for associates to check and resolve the issues. User inputs are fed back to the system to train and improve the accuracy of the algorithm. The algorithm can identify pallet labels that are missing, damaged, or covered.

Once a pallet label issue is detected, the system 100 adds it to a list for associates to check. The system 100 analyzes the location label detected by the robotic device(s) to provide an accurate location at the bay level. The user sees the pallet label issues as tasks in a prioritized to-do list in an inventory application running on a user device, such as the user device 116. The list is sorted by category to assist a user in finding the current location quickly and work more efficiently.

When tapping into each label issue, users can quickly see the information captured by the robotic devices, such as the accurate location of the pallet having the labeling issue and one or more real-time images of the pallet and/or a portion of the pallet.

In some embodiments, the label manager 130 adds an indicator to highlight the pallet having the pallet label. The image of the pallet having the labeling issue, in some embodiments, includes a highlight or other indicator associated with the pallet that has a missing or damaged label. This helps associates easily find where the issues occur, and which pallet has label issues. The detail page on the application optionally also gives guidance to help users analyze the label issues, including a “show-me-how” step-by-step instruction page with detailed instructions for correcting a pallet label issue in accordance with established standards or other criteria. The users can choose from the options under a “provide more info about the pallet” when it comes to different pallet label issues.

When choosing different options, the customized instructions provided to the users are led to different flows to either create a new label, print with an existing pallet ID, scan a pallet to verify, or scan a location to verify. User inputs are sent to the label manager 130. The label manager is retrained using the feedback provided by the user to reduce false positives and become more accurate. The feedback includes user input indicating whether a user was able to locate the pallet in question using the instructions, location information and pallet image provided with the enhanced pallet label exception data, input regarding whether a pallet label exception is a false positive associated with a pallet that does in fact have an accurate and readable label present on the pallet or whether the pallet label is missing or damaged. The feedback optionally also includes input identifying the type of pallet label issue, accuracy of a replacement pallet label, whether the user was able to correctly affix a replacement pallet label, etc.

After a user places the new (replacement) label on a pallet, the user is prompted to make sure the pallet labels are affixed in the right position on an exterior portion of the pallet in question. The user may be prompted to provide input regarding whether the new label is successfully placed on correct pallet. After the pallet label exception is resolved, managers or other users can track pallet label exceptions, including information regarding which user verified the labels and what actions were taken. This information is presented within an exception handling history page within a UI. This enables users to evaluate exception handling tasks (pallet label check tasks) in a more timely manner while also providing feedback to users.

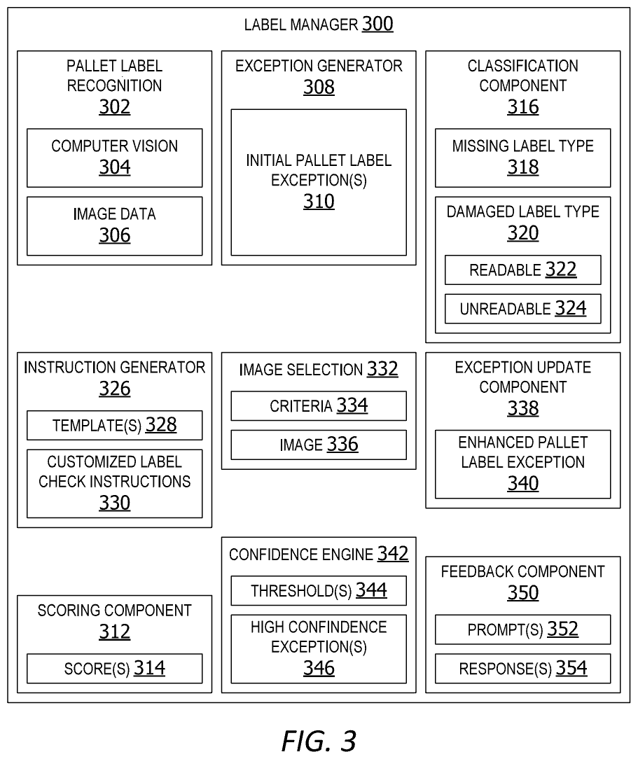

In some embodiments, a feedback component provides a prompt to a user via a user interface to obtain feedback from the user regarding the pallet and/or pallet label, as shown in FIG. 3 below. The user optionally updates a status of the pallet label by indicating whether the pallet label is damaged, missing, or present (undamaged). The user can optionally confirm that the pallet label is missing or present via a UI associated with the user device 116 and/or the user interface device 110.

In still other embodiments, the user is prompted to provide feedback regarding pallets and/or pallet label exceptions. In these examples, a determination is made whether feedback from the user is received. If feedback is received, the pallet label exception is updated based on the feedback. The feedback can include confirmation of correct pallet labeling, indication of incorrect labeling, correction of an incorrect label, and/or update of the status of a missing or damaged label.

In other embodiments, the feedback is used to fine-tune and/or retrain the label manager ML model(s). In these examples, feedback indicating whether the missing and/or damaged pallet label is correctly identified on a pallet is used to improve pallet label detection and recognition as well as improving accuracy of pallet label exception creation.

FIG. 2 is an exemplary block diagram illustrating a retail facility 200 including a plurality of pallets and image capture devices for capturing images of pallet labels. The retail facility 200 is any type of brick-and-mortar facility, such as a retail store. One or more image capture device(s) 202 generating image data 204 associated with one or more image(s) of one or more pallet(s) 206 containing one or more item(s) 208.

The image capture device(s) 202, in some embodiments, include one or more digital cameras capturing digital images of the pallet(s) 206. The digital image(s) include image data 204. In this example, the image capture device(s) 202 include one or more cameras mounted on one or more robotic device(s) 210. However, the embodiments are not limited to a camera mounted on a robotic device. In other embodiments, the image capture device(s) 202 include hand-held cameras, cameras mounted to a fixture, or any other type of camera. For example, the image capture device(s) 202 can optionally include a ceiling mounted camera, a camera mounted to a shelf, pillar, or other fixture.

The plurality of images 212 generated by the image capture device(s) 202 are optionally stored on a data storage device 214. The plurality of images 212 include images of the pallet(s) 206 and/or the pallet label(s) 216 affixed to one or more of the pallet(s) 206. The data storage device 214 is a device for storing data, such as, but not limited to, the data storage device 150 in FIG. 1. In other embodiments, the plurality of images 212 are stored on a cloud storage, such as, but not limited to, the cloud server 118 in FIG. 1. In this example, the data storage device 214 stores the plurality of images 212 and/or a plurality of exceptions 218. The plurality of exceptions includes one or more initial label exceptions and/or one or more enhanced pallet label exceptions. In other embodiments, the plurality of exceptions 218 and/or the plurality of images 212 are stored on a cloud storage or other remote data storage device which is accessed via a network, such as, but not limited to, the network 112 in FIG. 1.

The label manager 130 on the computing device 102 utilizes the plurality of images 212 to identify pallet label errors, such as missing pallet labels and/or damaged pallet labels. A damaged pallet label includes pallet labels that are torn, smudged, missing text, or obscured such that the pallet label cannot be accurately read or scanned. The label manager 130 generates an enhanced pallet label exception 220 associated with a pallet having a missing or damaged label. The enhanced pallet label exception includes customized label check instructions 222 and a real time image 224 of the pallet having the missing or damaged label. The instructions and image assist a user in quickly and accurately locating the pallet within the retail facility 200, as well providing instructions for correcting the pallet label issue by replacing the missing or damaged label.

In some embodiments, the robotic devices capture images of pallets used to detect pallet label issues with computer vision technology. The robotic devices scan pallets and capture images of the pallets throughout the retail facility 200 on a daily basis in this example. The algorithm identifies pallet labels that are missing, damaged, or covered (obscured). An obscured pallet label is classified as a damaged label in some embodiments.

Turning now to FIG. 3, an exemplary block diagram illustrating a label manager for providing customized pallet label check instructions with enhanced pallet label exceptions is shown. In some embodiments, a label manager 300 is a component for generating enhanced pallet label exceptions for resolving pallet label issues, such as, but not limited to, the label manager 130 in FIG. 1 and FIG. 2.

In some embodiments, a pallet label recognition 302 analyzes image data 306 using computer vision 304 algorithms to detect and recognize pallets and pallet labels in image(s) of pallets generated by image capture devices, such as, but not limited to, the image capture device(s) 120 in FIG. 1 and/or the image capture device(s) 202 in FIG. 2. The label manager 300 identifies a pallet having a missing or damaged pallet label by analyzing an image of the pallet. An exception generator 308 generates one or more initial pallet label exception(s) 310 associated with the pallet having the missing or damaged pallet label.

A scoring component 312 generates one or more confidence score(s) 314 for the initial pallet label exception(s) 310. Each confidence score indicates a degree of confidence associated with each initial pallet label exception. In other words, a score is assigned to each exception indicating a level of confidence in the determination of the pallet label recognition 302 that a pallet label is missing or damaged. A confidence engine 342 identifies high confidence exception(s) 346 by comparing the confidence score(s) 314 with one or more threshold(s) 344. If a confidence score is greater than or equal to a threshold, the exception is a high confidence exception. If the confidence score is less than the value of the exception, the exception is a low confidence exception. Low confidence exceptions are not presented to a user for a pallet label check. Only high confidence exceptions are approved for pallet label checks performed by a user in these examples.

In some embodiments, a classification component 316 classifies each initial pallet label exception according to a type of issue with the pallet label. The type can include a missing label type 318 or a damaged label type 320. The damaged label type includes damaged labels that are readable 322 and damaged labels that are unreadable 324. A damaged label can include labels that are ripped, torn, folded, obscured by other objects, and labels in which the text printed on the label is faded or unreadable.

An instruction generator 326, in some embodiments, creates customized label check instructions 330 based on the type of the issue associated with the pallet label. In some embodiments, the instruction generator 326 uses one or more template(s) 328 to generate the customized label check instructions 330. The customized label check instructions 330 guide a user in locating the pallet and correcting the type of the issue associated with the pallet label. The customized label check instructions 330 are different depending on the type of the label issue. For example, if the label is missing, the instructions include steps for creating a label to place on the pallet. However, if the pallet label is damaged, the instructions include steps for reprinting the label and placing the reprinted label on the pallet.

If multiple images of a pallet are available, an image selection 332 optionally analyzes the images using image selection criteria 334. The criteria includes rules for identifying the best image for utilization by a user in locating the pallet having the missing or damaged pallet label. In some embodiments, the criteria includes rules for identifying an image in which the pallet is centered within the image, such as centered within a bounding box and/or within a cropped image of the pallet.

An exception update component 338 updates the initial pallet label exception with the customized label check instructions to create an enhanced pallet label exception 340. The enhanced pallet label exception includes the customized label check instructions 330 and the real-time image 336 of the pallet. The enhanced pallet label exception 340 is presented to the user via a user interface.

In some embodiments, if a user performing a pallet label check determines that the label on the pallet is present on the pallet and readable (not missing or damaged), the pallet label exception is erroneous. In some embodiments, a feedback component 350 generates one or more prompt(s) 352 requesting the user feedback. The user feedback indicating the exception was erroneous is provided via one or more response(s) 354 input by the user. The feedback is utilized to retrain or fine-tune the label manager 300 to improve the accuracy of missing and damaged label identification.

FIG. 4 is an exemplary flow chart illustrating operation of the computing device to automatically generate enhanced pallet label exceptions for improving resolution of pallet label issues. The process 400 shown in FIG. 4 is performed by a label manager component, executing on a computing device, such as the computing device 102 or the user device 116 in FIG. 1.

The process begins by obtaining image(s) of a pallet at 402. The image(s) include one or more images generated by an image capture device, such as, but not limited to, the image capture device(s) 120 in FIG. 1 and/or the image capture device(s) 202 in FIG. 2. An initial pallet label exception is generated at 404. The initial pallet label exception is classified at 406. The classification includes a pallet label missing type or a pallet label damaged type. The label manager creates customized instructions at 408. The customized instructions are instructions for correcting a pallet label issue, such as, but not limited to, the instructions 142 in FIG. 1 and/or customized label check instructions 330 in FIG. 3. An enhanced pallet label exception is created at 410. The enhanced pallet label exception is presented to a user via a UI device at 412. The UI device is a device such as, but not limited to, the user interface device 110 and/or the UI device 122 in FIG. 2. A determination is made whether images for a next pallet are available at 414. If yes, the process iteratively executes operations 402 through 414 until images of a next pallet are unavailable. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to provide customized pallet label check instructions for enhanced pallet label exception handling. The process 500 shown in FIG. 4 is performed by a label manager component, executing on a computing device, such as the computing device 102 or the user device 116 in FIG. 1.

The process begins by receiving pallet image(s) at 502. The image(s) are generated by an image capture device. A determination is made whether the pallet label on each pallet in the pallet image(s) is good at 504. If yes, the image(s) of the pallet are stored at 506. The images are stored in a data storage device, such as, but not limited to, the data storage device 150 in FIG. 1 and/or the data storage device 214 in FIG. 2. If the image(s) do not show a good label at 504, a pallet label check task is generated at 508. The pallet label check task is a task associated with a pallet label exception. A determination is made whether the pallet associated with the pallet label check task is found by the user at 510. In this example, the user provides feedback to the system indicating whether the user found the correct pallet associated with the pallet label check task. The pallet is a pallet believed to have a missing or damaged label based on an analysis of the image(s) of the pallet. If the pallet is not found, the record associated with the pallet label check task is updated with a pallet not found at 512. If the pallet is found at 510, a determination is made whether the pallet label on the pallet is correct at 514. If a label is present on the pallet and the label is correct (not missing or damaged), the process terminates thereafter. In some embodiments, the pallet label exception is also closed out if the label is determined to be present and correct.

Returning to 514, if the pallet label is missing or damaged, the label manager generates instructions at 516. The instructions are pallet label check instructions customized based on the type of exception (missing label exception or damaged label exception). The instructions are presented to the user at 518. In some embodiments, the instructions are presented via a UI device. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to automatically handle pallet label checks using computer vision and optical character recognition. The process 600 shown in FIG. 4 is performed by a label manager component, executing on a computing device, such as the computing device 102 or the user device 116 in FIG. 1.

The process begins when a robotic device captures images of pallets at 602. Computer vision processing of the images is performed to detect pallets and pallet labels in the images at 604. The images are cropped at 606. Cropping the images eliminates objects in the images which are not of interest. In these examples, the images are cropped to remove objects other than the pallet and/or pallet label on the pallet. Optical character recognition (OCR) is applied to the cropped images of the pallet labels to read any visible text on the pallet label at 608. A determination is made whether the pallet label is readable at 610. If not, an exception is created at 612. The process terminates thereafter. If the pallet label text is readable at 610, the label manager assigns a confidence score at 614. The score is assigned to the pallet or to an initial pallet label exception. If the text on one or more of the pallet labels indicates that any of the pallets are do not inventory (DNI) pallets, the DNI pallets are filtered at 616. In other words, DNI pallets are ignored such that no pallet label exception handling is performed with regard to the DNI pallets. High confidence exceptions are sent to a user for handling in accordance with customized instructions associated with each exception at 618. The process terminates thereafter.

High confidence exceptions are determined based on a confidence score. The confidence score indicates a likelihood that a pallet has a missing or damaged label. In this example, exceptions associated with a pallet label having text that is not readable using the OCR is automatically designated as a high confidence exception due to the recognition of the pallet tag and the failure to read the text (pallet ID) on the label. In other embodiments, an exception having unreadable text is assigned a confidence score which is weighted to indicate the high likelihood of an unreadable label being damaged.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to update pallet label exceptions using feedback provided by a user. The process 700 shown in FIG. 4 is performed by a label manager component, executing on a computing device, such as the computing device 102 or the user device 116 in FIG. 1.

The process begins by generating an enhanced pallet label exception at 702. The exception is sent to a user device at 704. The user device is a computing device, such as, but not limited to, the computing device 102 and/or the user device 116 in FIG. 1. A determination is made whether the pallet associated with the exception is found by a user handling the exception at 706. A user handling (investigating and resolving) the exception is a user that has been assigned a pallet label check task to visually inspect the pallet label on a specific pallet associated with an enhanced pallet label exception. If the pallet is not found, the exception record is updated to indicate the failure to locate the pallet in the retail facility. The exception may be placed on a hold (freeze) or closed out due to the failure to locate the pallet. The process terminates thereafter.

If the pallet is found at 706, a determination is made whether the pallet label issue is found at 710. The pallet label issue can include a missing pallet label or a damaged pallet label. If no issue is found (pallet label is present and undamaged), the exception record is updated at 708. The record may be closed where the user feedback indicates the pallet label is present and correct (readable). The process terminates thereafter.

If the pallet label issue is found at 710, the label manager prompts the user to confirm the type of issue at 712. The issue type can include a missing label type or a damaged label type of issue. The label manager presents instructions for resolving the issue to the user at 714. The instructions are customized based on the type of issue indicated by the user. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

Referring now to FIG. 8, an exemplary flow chart illustrating operation of the computing device to customize exception handling instructions based on a type of the pallet label issue is shown. The process 800 shown in FIG. 4 is performed by a label manager component, executing on a computing device, such as the computing device 102 or the user device 116 in FIG. 1.

The process begins by receiving feedback from a user at 802. The user is a human user assigned to a pallet check task associated with handling an enhanced pallet label exception. A determination is made whether the exception was a false positive at 804. It is a false positive if a pallet label is present on the pallet and undamaged. If yes, the exception record is updated at 806. In some embodiments, the exception is also closed out. The process terminates thereafter.

If the exception is not a false positive at 804, the label manager prompts the user to confirm the type of issue at 808. A determination is made whether the type of issue is a missing label at 810. The determination is made based on the user feedback provided in response to the prompt. If the pallet label is not missing, a determination is made whether the pallet label is readable at 812. If yes, the label manager instructs the user to scan the label at 814. Scanning the label enables the inventory system to identify the pallet and/or the pallet contents. The user is instructed to print a label for the pallet at 818. The user is instructed to review the label prior to placing the label on the pallet at 820. The process terminates thereafter.

If the pallet label is present but not readable at 812, the system creates a new label for the pallet at 816. In some embodiments, the new label is created based on feedback from the user describing the contents of the pallet and/or other information obtained by the user during the visual inspection of the pallet. The label manager instructs the user to print the label at 818. The user is instructed to review the label prior to affixing the label to the pallet at 820. The process terminates thereafter.

In this example, a user is instructed to print a label used to replace a missing or damaged label. In other embodiments, the label manager automatically triggers printing of a label for placement on a pallet. The label manager instructs the user to review the label and affix the printed label to the pallet in these examples.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

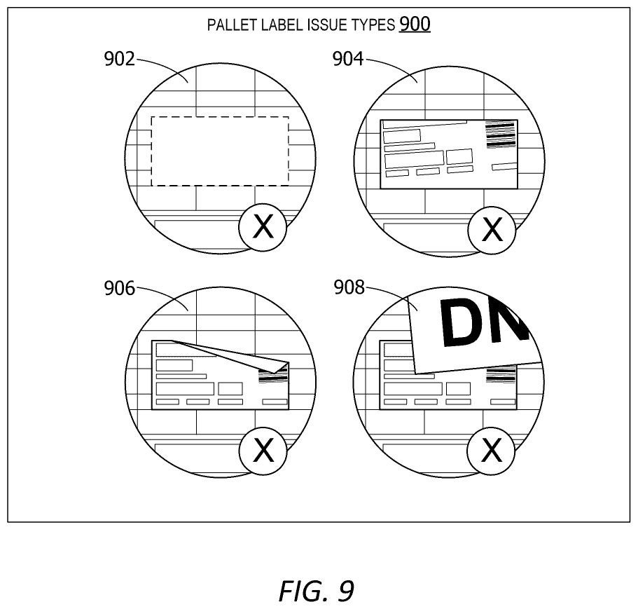

FIG. 9 is an exemplary diagram illustrating types of pallet label issues. The set of pallet label issue types 900 includes a missing pallet label 902, unreadable text 904 in which the text on the label is printed at an angle, a damaged label 906 in which the label is partially detached and folded over or torn, and a partially obscured label 908 in which the label is partially blocked from view by another object. When a label issue is detected, the label issue can include a missing pallet label, unreadable text on the label, a damaged label, and/or an obscured label, as shown in FIG. 9.

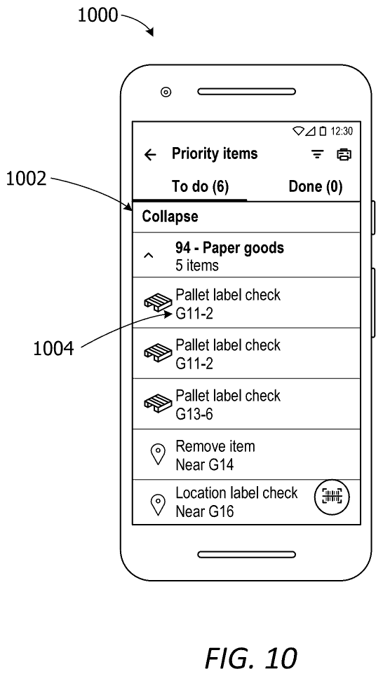

FIG. 10 is an exemplary screenshot 1000 illustrating pallet label check assignments for checking potential pallet label issues detected in images of pallets. In this example, a list of pallet check assignments are shown in an order of priority. Each pallet label check task includes accurate location information to assist a user in finding the pallet having the missing or damaged pallet label.

Once the label manager detects a pallet label issue, it adds it to a list 1002 for users to check. The list 1002 is optionally a collapsable sorted by category to help associates find labels with problems faster. In this example, the list 1002 is a pallet label check task list with a prioritized list of pallets potentially having a pallet label issue. The pallets are prioritized based on confidence scores, in some embodiments. The system analyzes the location label detected by mobile robotic devices to provide an accurate location 1004 at the bay level, such as “G11-2.” Accurate bay location helps users find the issue easily. Users visually inspect the pallet label issues as tasks provided in the prioritized to-do list in an application provided on a user device, such as the user device 116 in FIG. 1. The list 1002 is sorted by category to help each user find the location of each pallet quickly and work more efficiently.

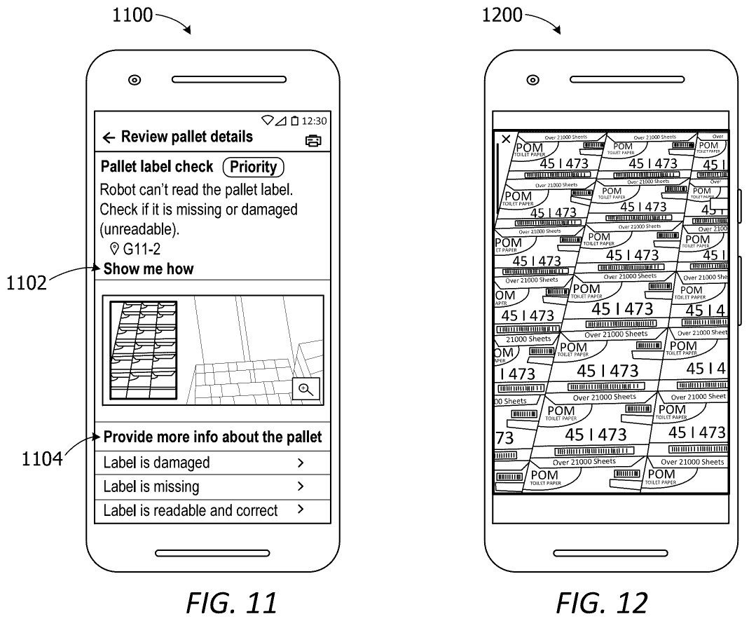

Turning now to FIG. 11, an exemplary screenshot 1100 illustrating a prompt for more information associated with a pallet label issue is shown. In this example, a user is prompted to provide more information regarding the type of pallet label issue that is being observed by the user. The type of pallet label issue includes a missing label or damaged label. The user can also provide feedback indicating the pallet label is readable and correct.

When tapping into each label issue, a user can quickly see the information captured in image data and/or other sensor data generated by the robotic devices, such as the accurate location of the issue and a real-time image with the pallet highlighted. This helps users easily find where the issues occur, and which pallet has label issues. The detail page also gives guidance to help users analyze the label issues, including a “Show-me-how” page. This helps users make sure the labels meet store standards. Users can simply choose from the following for options under “Provide more information about the pallet” when it comes to different pallet label issues.

In some embodiments, a tip and “show me how” link 1102 help users fix the label issues. In this example, a user can provide more information about the pallet label 1104. The user can choose from four options to solve the pallet label issues. The four options shown includes a label that is damaged, a label that is missing, and/or a label that is readable and correct. However, the examples are not limited to these options. In other examples, the options can include an obscured label, or other possible labeling issues.

FIG. 12 is an exemplary screenshot 1200 illustrating a real time image of a pallet associated with an enhanced pallet label exception. In this example, the UI is displaying a real time image of a pallet. The user can zoom in to view the image in greater detail. The user can zoom in to view the real-time photo taken by a mobile robotic device to find the exact pallet with label issues. The image assists the user in identifying the correct pallet associated with the enhanced pallet label exception.

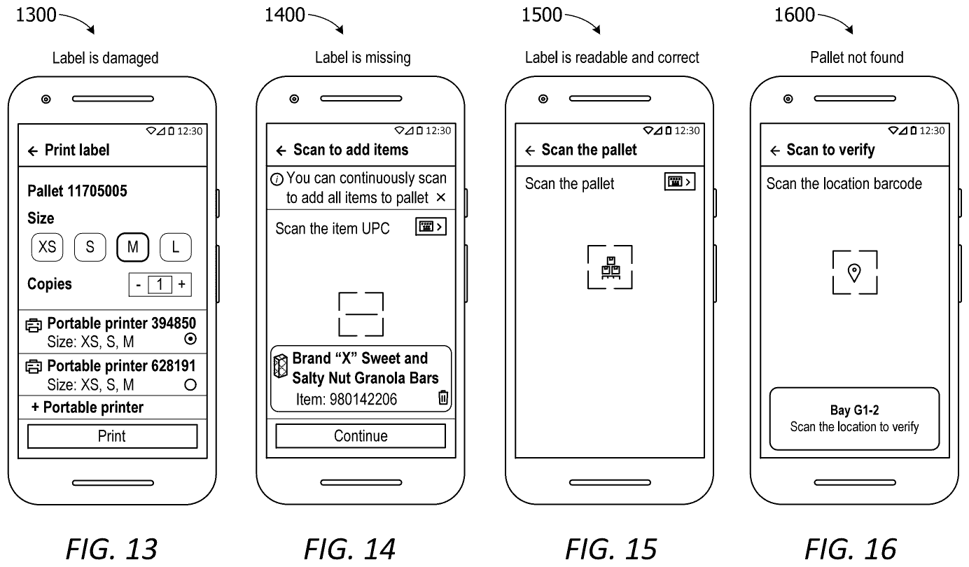

FIG. 13 is an exemplary screenshot 1300 illustrating a set of instructions output to a user associated with a pallet label exception associated with a damaged label. FIG. 14 is an exemplary screenshot 1400 illustrating a set of instructions provided to a user for a pallet label exception associated with a missing label issue. FIG. 15 is an exemplary screenshot 1500 illustrating a set of instructions provided to a user associated with a pallet label that is readable and correct. FIG. 16 is an exemplary screenshot 1600 illustrating a set of instructions output to a user associated with a pallet that remains unlocated by the user (pallet not found).

When choosing different options, a user is led to different flows to either create a new label, print with an existing pallet ID, scan a pallet to verify, or scan a location to verify. User inputs are sent back to the back-end label manager. The algorithm is trained to reduce false positives and become more accurate.

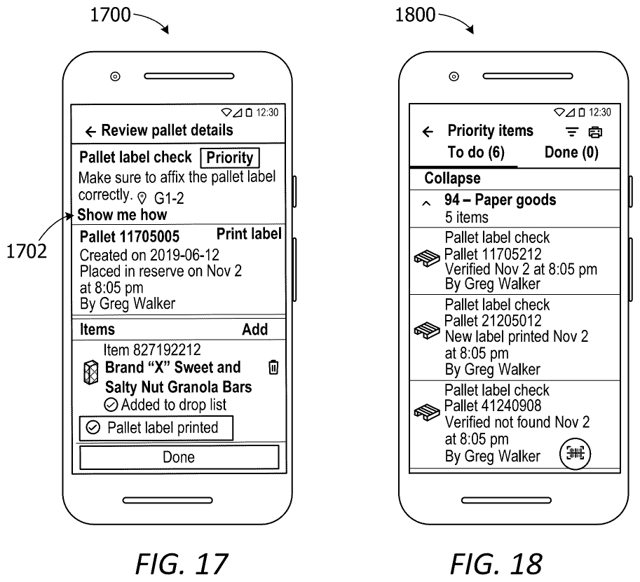

FIG. 17 is an exemplary screenshot 1700 illustrating step by step instructions provided to a user attempting to resolve an issue associated with a pallet label exception. In this example, a “show me how” link 1702 provides tips and instructions to a user to ensure users place labels properly.

FIG. 18 is an exemplary screenshot 1800 illustrating a history page feature enabling users to track multiple exceptions via an application. In this example, the history page includes a list of pallet label check tasks which have already been completed. Users, such as managers, can track who worked on a given task such that they can give feedback when needed. For example, a user can view each pallet label check task and see which person performed the check, a pallet number, date, and time is provided. However, the embodiments are not limited to the information shown in FIG. 18. In other embodiments, other information not shown in FIG. 18 may also be included in the pallet label check history page.

After a user places the new labels on a pallet or other object, the user is prompted to make sure the pallet label has been placed in the right position on the pallet. After the user resolves the label issues, managers or other users can track who verified the labels and what actions were taken in the history page. Now managers can evaluate the work in a more timely manner and give feedback to users.

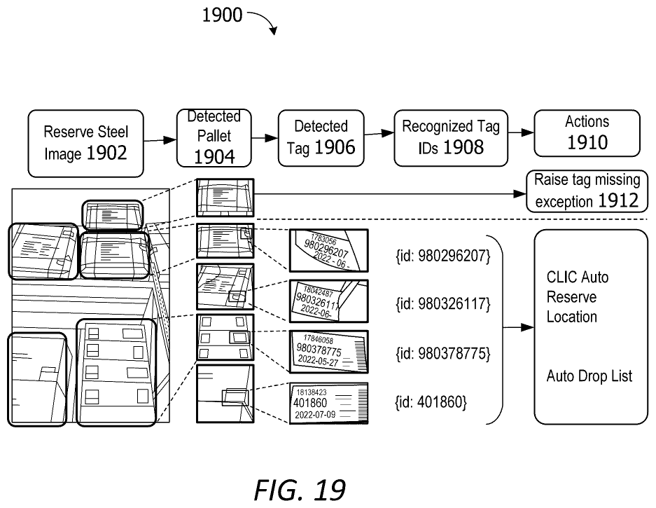

FIG. 19 is an exemplary diagram illustrating detection of pallets and pallet labels using computer vision object detection and recognition. The process 1900 includes analysis of images of pallets in a reserve area or any other area associated with a retail facility, such as an indoor area, a partially enclosed area, and/or an outdoor storage area associated with the retail facility. The process begins by receiving or obtaining a reserve steel image 1902. A reserve steel image is an image including a portion of an item storage structure or other pallet storage area. The reserve steel is a pallet storage area which is not accessible to customers of a retail facility, such as a store. The images are analyzed using computer vision to detect and recognize pallets and pallet labels. In this example, a pallet is detected 1904. A tag on the pallet is detected 1906. A pallet ID is obtained from the recognized tag 1908. The pallet labels are referred to as pallet tags in this example. The recognized tags are read to obtain the pallet IDs and/or item IDs for contents of the pallets. Actions 1910 are taken in response to pallet label issues, such as raising a tag missing exception 1912 if a tag (pallet label) is missing.

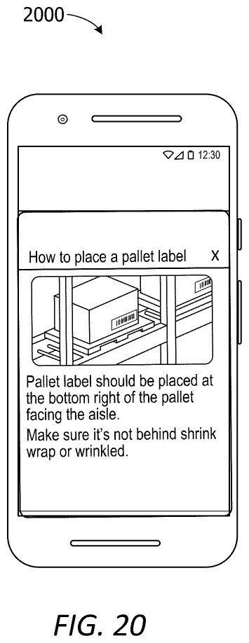

FIG. 20 is an exemplary diagram illustrating a “show me how” page 2000 including instructions and/or other tips to assist a user in correctly placing a label on a pallet or other item. In this example, the instructions provide information regarding where to place the label on a pallet. The instructions include one or more images and/or text instructions to guide the user. In other embodiments, the “show me how” page 2000 can also include verbal (audio) instructions. The “show me how” page 2000 is presented to a user via a UI in response to the user selecting a “show me how” link, as discussed in FIG. 17 above.

### Additional Examples

In some embodiments, the system utilizes driverless machines, such as mobile robotic devices, utilizing a dual function design including a powerful scanning accessory fitted to the robotic devices. The robotic devices roam throughout an interior and/or exterior store or portion of a store capturing images of pallets and/or pallet labels on the pallets. Installed on the mobile robotic devices, these cloud-connected towers scan the pallet labels capturing data as each robotic device moves around the store. Using computer vision, the label manager analyzes the data. The label manager automatically updates locations of items and pallets in real-time. In this manner, the system saves time and reduces manual labor expended in maintaining inventory up-to-date.

In some embodiments, the system provides a pallet label check feature in an inventory application that leverages mobile robotic devices and computer vision technology to solve the problem of identifying missing and damaged pallet labels in real-time. The system utilizes mobile robotic devices to identify pallets that do not have readable labels and creates exceptions for store associates (users) to resolve missing tags.

A label manager component presents a set of instructions for resolving the pallet label exception responsive to the user feedback indicating the type of exception, in one example. The type of exception includes a missing label exception and/or a damaged label exception. Different types of exceptions trigger different sets of instructions. For example, if a label is missing instructions are provided for adding a label. Likewise, if the label is present but damaged, incorrect labeling, or unreadable, the system provides a different set of instructions for replacing the label and/or otherwise correcting the error. Once completed, the system prompts the user to indicate whether a correct pallet label is now present on the pallet. The user, in some embodiments, corrects the label if the label is rejected/incorrect. The system can prompt the user to capture one or more images of the pallet label as part of the pallet label exception resolution process.

In another example, the CV model(s) used to detect and identify the pallet labels using images of the pallets are implemented as part of the label manager that provides the instructions to the user. However, in other embodiments, the CV model(s) are separate components from the label manager. In these examples, the label manager obtains the pallet label detection and/or recognition results from the CV models.

In yet another example, the CV models are implemented on a computing device. However, in other embodiments, the CV model(s) are implemented on a separate computing device from the computing device implementing the label manager and/or on a cloud server.

In other embodiments, the label manager does not trigger a pallet label exception/assign a user to manually inspect a pallet for a pallet label issue unless there is a high probability that the label is actually missing, damaged, obscured or otherwise requiring correction. In such cases, the label manager assigns a score to each pallet associated with a potential pallet label issue. If a score exceeds a threshold level, the exception is triggered. However, if the score is below the threshold, the exception is not triggered. In other words, a human user is not alerted to a possible labeling issue unless the system is confidence that there is pallet label that is missing or damaged. This reduces false positives and prevents wasting associate time spent investigating potential pallet label issues. It further conserves system resources by reducing time spent creating and resolving pallet label exceptions.

In an example scenario, a robotic scanning device captures images and/or other scan data associated with pallets and pallet labels as the robotic device moves around the retail facility. The image data and/or scan data is analyzed to detect pallets having missing or damaged labels. A damaged label includes labels that are covered or obscured by other objects, such as stickers or tape on the pallet, as well as objects which are positioned in front of the pallet such that the robotic device cannot scan the label or capture an image of the entire label. When an issue is detected, the data is sent to a label manager for resolution. A user follows customized instructions provided by the label manager (application) to resolve the issue. A location label in proximity to the pallet and/or the robotic device is used to identify an accurate location of the pallet having the label issue. The location information is provided to the user with a real time image of the pallet in question to assist the user in quickly locating the pallet. The instructions and image(s) are presented to the user via a UI. In the course of following the instructions and providing feedback in response to prompts, the user is led along different flows to create new labels, reprint an original label, scan a location ID, scan an item on the pallet, etc. In other words, the instructions are changed/updated in real-time based on user feedback indicating the condition/state of the pallet and pallet label. The feedback is also fed back into the system as training data to reduce false positives and improve accuracy of the pallet label issue detection, thereby improving performance of the algorithms used to detect and resolve pallet label issues.

In other embodiments, robotic devices equipped with computer vision technology detects pallet label issues while scanning throughout a retail facility (store) daily. Detected issues are added to a prioritized to-do list in an inventory application for users to check and resolve the issues. User inputs are fed back to the system to train and improve the accuracy of the algorithm. In this manner, the system reduces manual labor required to find pallet exceptions. Moreover, increasing the number of pallets with readable labels saves user time locating pallets and updating inventory by having robotic devices and label manager component automatically update reserve inventory locations on a regular basis, such as a daily basis.

Alternatively, or in addition to the other embodiments described herein, examples include any combination of the following:
assign a score for each initial label exception in a plurality of initial label exceptions associated with a plurality of objects within a retail facility;
identify a set of high confidence initial label exceptions in the plurality of initial label exceptions using the score assigned to each initial label exception;
generate the customized label check instructions for checking labels on a set of one or more objects associated with the set of high confidence initial label exceptions, wherein the customized label check instructions are presented to at least one user via a user interface device;
identify a plurality of confidence scores associated with a plurality of label exceptions having confidence scores within a threshold range;
select initial label exceptions having a confidence score within the threshold range;
update each selected initial label exception with a classification of the type of issue associated with the label and customized label check instructions for resolving the type of the issue associated with each label;
identify a selected object having a label with text instructions identifying the object as an object to be excluded from inventory using optical character recognition;
filter the identified object from a plurality of objects undergoing label check;
generate a first set of customized label check instructions for resolving a first type of issue associated with a missing label, wherein the first set of customized label check instructions includes instructions for creating a new label for the object which is missing the label;
generate a second set of customized label check instructions for resolving a second type of issue associated with an unreadable label, wherein the second set of customized label check instructions includes instructions for replacing a damaged label, wherein text on the damaged label is unreadable;
generate a third set of customized label check instructions for resolving a third type of issue associated with a partially damaged label which is present and at least partially readable, wherein the partially damaged label is at least partially unreadable;
update an inventory system using information associated with a replaced label responsive to receiving an indication that the issue associated with the enhanced label exception is resolved;
prompt a user to provide feedback regarding the enhanced label exception, wherein the feedback comprises an indication whether the issue associated with the enhanced label exception is a correct label exception accurately identifying a label issue or a false positive;
using the feedback associated with a plurality of enhanced label exceptions to retrain a label manager generating the enhanced label exceptions;
assign a score for each initial pallet label exception in a plurality of initial pallet label exceptions associated with a plurality of pallets within a retail facility;
identify a set of high confidence initial pallet label exceptions in the plurality of initial pallet label exceptions using the score assigned to each initial pallet label exception;
generate the customized label check instructions for checking pallet labels on a set of pallets associated with the set of high confidence initial pallet label exceptions, wherein the customized label check instructions are presented to at least one user via a user interface device;
identify a plurality of confidence scores associated with a plurality of pallet label exceptions having confidence scores within a threshold range;
select initial pallet label exceptions having a confidence score within the threshold range;
update each selected initial pallet label exception with a classification of the type of issue associated with the pallet label and customized label check instructions for resolving the type of the issue associated with each pallet label;
identify a pallet having a pallet label with text instructions identifying the pallet as a pallet to be excluded from inventory using optical character recognition;
filter the identified pallet from a plurality of pallets undergoing pallet label check;
generate a first set of customized label check instructions for resolving a first type of issue associated with a missing pallet label, wherein the first set of customized label check instructions includes instructions for creating a new label for a pallet which is missing a pallet label;
generate a second set of customized label check instructions for resolving a second type of issue associated with an unreadable pallet label, wherein the second set of customized label check instructions includes instructions for replacing a damaged label which is present on the pallet, wherein text on the damaged label is unreadable;
generate a third set of customized label check instructions for resolving a third type of issue associated with a partially damaged pallet label which is present and at least partially readable, wherein the partially damaged pallet label is at least partially unreadable;
update an inventory system using information associated with a replaced pallet label responsive to receiving an indication that the issue associated with the enhanced pallet label exception is resolved;
prompt a user to provide feedback regarding the enhanced pallet label exception, wherein the feedback comprises an indication whether the issue associated with the enhanced pallet label exception is a correct pallet label exception accurately identifying a pallet label issue or a false positive;
using the feedback associated with a plurality of enhanced pallet label exceptions to retrain a label manager generating the enhanced pallet label exceptions.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some embodiments, the operations illustrated in FIG. 4, FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of pallet label check, the method comprising obtaining an image of a pallet having an issue associated with a pallet label that is missing or unreadable, the image generated by an image capture device; generating an initial pallet label exception responsive to a determination the pallet label is absent or unreadable; classifying the initial pallet label exception according to a type of issue with the pallet label; creating customized label check instructions based on classification of the type of the issue with the pallet label, wherein the customized label check instructions guide a user in locating the pallet and correcting the type of issue associated with the pallet label; creating an enhanced pallet label exception including the customized label check instructions and a real-time image of the pallet; and providing the enhanced pallet label exception with the customized label check instructions via a user interface device enabling improved efficiency locating and correcting the issue associated with the pallet label.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some embodiments, to a wireless technology standard for exchanging data over short distances using short wavelength radio transmission. The term “NFC” as used herein refers, in some embodiments, to a short-range high frequency wireless communication technology for the exchange of data over short distances.

While no personally identifiable information is tracked by aspects of the disclosure, examples have been described with reference to data monitored and/or collected from the users. In some embodiments, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for pallet label checks. For example, the elements illustrated in FIG. 1, FIG. 2, and FIG. 3, such as when encoded to perform the operations illustrated in FIG. 4, FIG. 5, FIG. 6, FIG. 7, and FIG. 8, constitute exemplary means for capturing an image of a pallet by an image capture device; exemplary means for determining whether a pallet label is present and readable on at least a portion of the pallet using computer vision and optical character recognition; exemplary means for storing the image in a data storage device responsive to a determination the pallet label is present and readable; exemplary means for generating an initial pallet label exception responsive to a determination the pallet label is absent or unreadable; exemplary means for assigning a confidence score to the initial pallet label exception, the confidence score indicating a degree of confidence that the pallet label is actually absent or unreadable; exemplary means for classifying the initial pallet label exception according to a type of issue with the pallet label responsive to the assigned confidence score exceeding a threshold score; exemplary means for creating customized label check instructions based on classification of the type of the issue with the pallet label, wherein the customized label check instructions guide a user in locating the pallet and correcting the type of issue associated with the pallet label; exemplary means for updating the initial pallet label exception with the customized label check instructions to create an enhanced pallet label exception, the enhanced pallet label exception comprising the customized label check instructions and a real-time image of the pallet; and exemplary means for presenting the enhanced pallet label exception with the customized label check instructions via a user interface device enabling improved efficiency locating and correcting the issue associated with the pallet label.

Other non-limiting examples provide one or more computer storage devices having a first computer-executable instructions stored thereon for providing enhanced pallet label exceptions. When executed by a computer, the computer performs operations including identifying a pallet having a missing or damaged pallet label using an image of the pallet, the image generated by an image capture device; generating an initial pallet label exception associated with the pallet having the missing or damaged pallet label; assigning a confidence score to the initial pallet label exception, the confidence score indicating a degree of confidence associated with the initial pallet label exception; classifying the initial pallet label exception according to a type of issue with the pallet label responsive to the assigned confidence score exceeding a threshold score, the type of the issue comprising a missing label type of issue or a damaged label type of issue; creating customized label check instructions based on the type of the issue associated with the pallet label, wherein the customized label check instructions guide a user in locating the pallet and correcting the type of the issue associated with the pallet label; updating the initial pallet label exception with the customized label check instructions to create an enhanced pallet label exception, the enhanced pallet label exception comprising the customized label check instructions and a real-time image of the pallet; and presenting the enhanced pallet label exception with the customized label check instructions via a user interface device enabling improved efficiency locating and correcting the issue associated with the pallet label.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A”and “B”(optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for label checking, the system comprising:
a processor; and
a computer-readable medium storing instructions that are operative upon execution by the processor to:
identify an object of interest having a label that is missing or damaged using an image of the object, the image generated by an image capture device;
generate an initial label exception associated with the object of interest having the label;
assign a confidence score to the initial label exception, the confidence score indicating a degree of confidence associated with the initial label exception;
classify the initial label exception according to a type of issue with the label responsive to the assigned confidence score exceeding a threshold score, the type of the issue comprising a missing label type of issue or a damaged label type of issue;
create customized label check instructions based on the type of the issue associated with the label, wherein the customized label check instructions guide a user in locating the object of interest and correcting the type of the issue associated with the label;
update the initial label exception with the customized label check instructions to create an enhanced label exception, the enhanced label exception comprising the customized label check instructions and a real-time image of the object of interest; and
present the enhanced label exception with the customized label check instructions via a user interface device enabling improved efficiency locating and correcting the issue associated with the label.

2. The system of claim 1, wherein the instructions are further operative to:
assign a score for each initial label exception in a plurality of initial label exceptions associated with a plurality of objects within a retail facility;
identify a set of high confidence initial label exceptions in the plurality of initial label exceptions using the score assigned to each initial label exception; and
generate the customized label check instructions for checking labels on a set of objects associated with the set of high confidence initial label exceptions, wherein the customized label check instructions are presented to at least one user via a user interface device.

3. The system of claim 1, wherein the instructions are further operative to:
identify a plurality of confidence scores associated with a plurality of label exceptions having confidence scores within a threshold range;
select initial label exceptions having a confidence score within the threshold range; and
update each selected initial label exception with a classification of the type of issue associated with the label and customized label check instructions for resolving the type of the issue associated with each label.

4. The system of claim 1, wherein the instructions are further operative to:
identify a selected object having a label with text instructions identifying the object as an object to be excluded from inventory using optical character recognition; and
filter the identified object from a plurality of objects undergoing label check.

5. The system of claim 1, wherein the instructions are further operative to:
generate a first set of customized label check instructions for resolving a first type of issue associated with a missing label, wherein the first set of customized label check instructions includes instructions for creating a new label for the object which is missing the label;
generate a second set of customized label check instructions for resolving a second type of issue associated with an unreadable label, wherein the second set of customized label check instructions includes instructions for replacing a damaged label, wherein text on the damaged label is unreadable; and
generate a third set of customized label check instructions for resolving a third type of issue associated with a partially damaged label which is present and at least partially readable, wherein the partially damaged label is at least partially unreadable.

6. The system of claim 1, wherein the instructions are further operative to:
update an inventory system using information associated with a replaced label responsive to receiving an indication that the issue associated with the enhanced label exception is resolved.

7. The system of claim 1, wherein the instructions are further operative to:
prompt a user to provide feedback regarding the enhanced label exception, wherein the feedback comprises an indication whether the issue associated with the enhanced label exception is a correct label exception accurately identifying a label issue or a false positive; and
using the feedback associated with a plurality of enhanced label exceptions to retrain a label manager generating the enhanced label exceptions.

8. A method for label checking, the method comprising:
obtaining an image of an object having an issue associated with a label that is missing or unreadable, the image generated by an image capture device;
generating an initial label exception responsive to a determination the label is absent or unreadable;
classifying the initial label exception according to a type of issue with the label;
creating customized label check instructions based on classification of the type of the issue with the label, wherein the customized label check instructions guide a user in locating the object and correcting the type of issue associated with the label;
creating an enhanced label exception including the customized label check instructions and a real-time image of the object; and
providing the enhanced label exception with the customized label check instructions via a user interface device enabling improved efficiency locating and correcting the issue associated with the label.

9. The method of claim 8, further comprising:
assigning a score for each initial label exception in a plurality of initial label exceptions associated with a plurality of objects within a retail facility;
identifying a set of high confidence initial label exceptions in the plurality of initial label exceptions using the score assigned to each initial label exception; and
generating the customized label check instructions for checking labels on a set of s associated with the set of high confidence initial label exceptions, wherein the customized label check instructions are presented to at least one user via a user interface device.

10. The method of claim 8, further comprising:
identifying a plurality of confidence scores associated with a plurality of initial label exceptions having confidence scores within a threshold range;
selecting a set of initial label exceptions from the plurality of initial label exceptions having a confidence score within the threshold range; and
updating each selected initial label exception with a classification of the type of issue associated with the label and customized label check instructions for resolving the type of the issue associated with each label.

11. The method of claim 8, further comprising:
analyzing images of labels associated with a plurality of objects within a retail facility using optical character recognition;
identifying a selected object having a label with text instructions identifying the object to be excluded from inventory; and
filtering the identified object from the plurality of objects undergoing label check.

12. The method of claim 8, further comprising:
generating a set of customized label check instructions for resolving a first type of issue associated with a missing label, wherein the customized label check instructions includes instructions for creating a new label.

13. The method of claim 8, further comprising:
generating customized label check instructions for resolving a second type of issue associated with an unreadable label, wherein the customized label check instructions includes instructions for replacing a damaged label, wherein text on the damaged label is unreadable.

14. The method of claim 8, further comprising:
generating customized label check instructions for resolving a third type of issue associated with a partially damaged label which is present and at least partially readable, wherein the partially damaged label is at least partially unreadable.

15. One or more computer storage devices having computer-executable instructions stored thereon, which, upon execution by a computer, cause the computer to perform operations comprising:
capturing an image of an object by an image capture device;
determining whether a label is present and readable on at least a portion of the object using computer vision and optical character recognition;
storing the image in a data storage device responsive to a determination the label is present and readable;
generating an initial label exception responsive to a determination the label is absent or unreadable;
assigning a confidence score to the initial label exception, the confidence score indicating a degree of confidence that the label is actually absent or unreadable;
classifying the initial label exception according to a type of issue with the label responsive to the assigned confidence score exceeding a threshold score;
creating customized label check instructions based on classification of the type of the issue with the label, wherein the customized label check instructions guide a user in locating the object and correcting the type of issue associated with the label;
updating the initial label exception with the customized label check instructions to create an enhanced label exception, the enhanced label exception comprising the customized label check instructions and a real-time image of the object; and
presenting the enhanced label exception with the customized label check instructions via a user interface device enabling improved efficiency locating and correcting the issue associated with the label.

16. The one or more computer storage devices of claim 15, wherein the operations further comprise:
assign a score for each initial label exception in a plurality of initial label exceptions associated with a plurality of objects within a retail facility;
identify a set of high confidence initial label exceptions in the plurality of initial label exceptions using the score assigned to each initial label exception; and
generate the customized label check instructions for checking labels on a set of objects associated with the set of high confidence initial label exceptions, wherein the customized label check instructions are presented to at least one user via a user interface device.

17. The one or more computer storage devices of claim 15, wherein the operations further comprise:
identify a plurality of confidence scores associated with a plurality of initial label exceptions having confidence scores within a threshold range;
select initial label exceptions having a confidence score within the threshold range; and
update each selected initial label exception with a classification of the type of issue associated with the label and customized label check instructions for resolving the type of the issue associated with each label.

18. The one or more computer storage devices of claim 15, wherein the operations further comprise:
delete initial label exceptions associated with objects having a label with text instructions identifying the object to be excluded from inventory.

19. The one or more computer storage devices of claim 15, wherein the operations further comprise:
generate a first set of customized label check instructions for resolving a first type of issue associated with a missing label, wherein the first set of customized label check instructions includes instructions for creating a new label for the object which is missing a label;
generate a second set of customized label check instructions for resolving a second type of issue associated with an unreadable label, wherein the second set of customized label check instructions includes instructions for replacing a damaged label, wherein text on the damaged label is unreadable; and
generate a third set of customized label check instructions for resolving a third type of issue associated with a partially damaged label which is present and at least partially readable, wherein the partially damaged label is at least partially unreadable.

20. The one or more computer storage devices of claim 15, wherein the operations further comprise:
update an inventory system using information associated with a replaced label responsive to receiving an indication that the issue associated with the enhanced label exception is resolved.
